(19) United States
(12) Patent Application Publication
(10) Pub. No.: US 2025/0199317 A1
(43) Pub. Date: Jun. 19, 2025

(54) Head-Mounted Display with Volume Substrate-Guided Holographic Continuous Lens Optics

(71) Applicant: Luminit LLC, Torrance, CA (US)

(72) Inventor: Fedor Dimov, Torrance, CA (US)

(21) Appl. No.: 18/991,000

(22) Filed: Dec. 20, 2024

Related U.S. Application Data
(63) Continuation of application No. 17/091,493, filed on Nov. 6, 2020, now abandoned.
Application No. 17/091,493 is a continuation-in-part of application No. 16/800,531, filed on Feb. 25, 2020, now abandoned.

(51) Int. Cl. G02B 27/01; G02B 27/42

(52) U.S. Cl. CPC G02B 27/0172; G02B 27/4238; G02B 2027/0174

(57) ABSTRACT

This application relates to a see-through head-mounted display using recorded substrate-guided holographic continuous lens (SGHCL) and a microdisplay with laser illumination. The high diffraction efficiency of the volume SGHCL creates very high luminance of the virtual image.

### CROSS-REFERENCE TO RELATED APPLICATIONS

The present disclosure is a continuation of U.S. Non-Provisional application Ser. No. 17/091,493, filed Nov. 6, 2020, which is a continuation-in-part of U.S. Non-Provisional application Ser. No. 16/800,531, filed Feb. 25, 2020, which is hereby incorporated herein in its entirety by this reference.

### TECHNICAL FIELD

This application is directed to a monochrome or full-color Head-Mounted Display (HMD) featuring volume substrate-guided holographic reflection continuous lens (SGHCL) optics containing a scanning laser beam or a microdisplay with laser-based illumination.

### BACKGROUND

It is estimated that the combined revenues for sales of augmented reality (AR), virtual reality (VR), and smart glasses will approach $80 billion by the year 2025. About half of that revenue is directly proportional to the hardware of the devices and the optics are key. However, despite this huge demand, such devices remain difficult to manufacture and the quality is lacking. One reason is that traditional optical elements are limited to the laws of refraction and reflection, which require cumbersome custom optical elements that are difficult to fabricate to form a usable image in the wearer's visual field. Another reason is that refractive optical materials are heavy in weight. Still another reason is that current devices offer a narrow field of view. An additional reason is that current devices have significant color dispersion, crosstalk, and degradation. Yet another reason is that current designs based on diffractive or holographic optics have low diffraction efficiency (DE) of about only I 0-15%. These limitations result in devices that are less than satisfactory. Thus, there exists a need for an effective solution to the problem of the inability to manufacture and provide quality HMDs, which the present disclosure addresses.

### BRIEF SUMMARY

The present disclosure concerns a holographic substrate-guided head-mounted see-through display comprising (a) an image source comprising a scanning laser beam or a microdisplay with laser-based illumination; (b) an edge-illuminated transparent substrate, and; (c) a single volume SGHCL.

In one aspect, the holographic substrate-guided head-mounted see-through display contains (a) an image source comprising a microdisplay with laser-based illumination; (b) an edge-illuminated transparent substrate comprising an angled edge or an index-matched transparent prism, and; (c) a single volume holographic lens comprising a reflection SGHCL, which is index-matched to the substrate, and which is rotated 180° around a perpendicular axis of symmetry passing through the center of the SGHCL; wherein upon playback, an incident guided beam experiences total internal reflection and hits the SGHCL at Bragg condition.

In another aspect, the holographic substrate-guided head-mounted display has a substrate comprising a thickness of about 3-6 mm. Another embodiment is that the substrate and the prism each comprise glass, quartz, acrylic plastic, polycarbonate plastic, or a mixture thereof. Yet another option is that the substrate comprises a single plate or multiple plates. Still another option is that the substrate comprises a 15°-25° angled edge or a 15°-25° index-matched prism.

In one embodiment of the holographic substrate-guided head-mounted display, the microdisplay comprises a laser-illuminated monochrome or an RGB (full color) liquid crystal on silicon (LCOS), digital light processing (DLP), or liquid crystal display (LCD).

In another embodiment, the holographic substrate-guided head-mounted display has a substrate, opposite to an eye of the viewer, which comprises an anti-reflective coating. In yet another embodiment, the substrate comprises a curved shape. In still another embodiment, the substrate comprises prescription glasses. In yet another embodiment, the substrate comprises a unitary body or a plurality of bodies made of the same material or different materials. In another embodiment, the substrate comprises a shape including rectangular, oval, circular, tear-drop, hexagon, rectangular with rounded corners, square, or a mixture thereof. In another embodiment, one or more edges of the substrate comprise a light absorptive coating.

In a different embodiment of the holographic substrate-guided head-mounted display, the microdisplay is directly attached to the substrate or comprises a gap relative to the substrate.

In another embodiment of the holographic substrate-guided head-mounted display, the SGHCL comprises a first side and a second side opposite to the first side; and wherein, upon playback, the SGHCL has a diffracted beam on the first side and has a playback beam on the second side. In yet another embodiment, upon playback, the SGHCL has a diffracted beam and a playback beam on a same side.

In one embodiment of the holographic substrate-guided head-mounted display, a retrieved image comprises a monochrome or RGB (full-color) image.

In another embodiment, the holographic substrate-guided head-mounted display comprises a focused, modulated, scanning laser beam and a diffuser.

Also included herein is a method of recording a volume reflection SGHCL comprising shining two beams onto a holographic polymer index-matched to a substrate, wherein a first recording beam is guided from an edge of the substrate and convergent to a first focus point and a second recording beam is a divergent beam, and wherein both beams cover the holographic polymer.

Another embodiment of the method of recording the volume reflection SGHCL, the substrate is index-matched to a first rectangular block having an angled edge or an index-matched prism; wherein a first recording beam is guided and convergent with focus in a recording point 01 using a long focus lens and a second recording beam is divergent with focus 02, in a plane created by a high numerical aperture lens; wherein a second rectangular block is placed underneath the holographic polymer to avoid total internal reflection of a guided beam back from a bottom surface of the holographic polymer to avoid recording unwanted transmission SGHCL; wherein the recording convergent beam comprises angles with the substrate and holographic polymer less than or equal to about 48°; wherein a reliable guided angle is greater than about 12°; wherein a microdisplay or focused laser beams are positioned at equivalent focus of the recording convergent beam and the divergent beam; wherein a cylinder lens is used in the convergent recording beam to minimize aberrations; wherein a position, tilt and focus of the cylinder lens are adjusted to minimize aberrations; wherein an HMD image comprises a virtual image coming from infinity; and wherein a minimum angle of a convergent beam with a holographic polymer surface comprises about 14° and a maximal angle of the convergent beam with the holographic polymer surface comprises about 31° with a central beam having 15°-25° angle.

The HMD of this application has several benefits and advantages. One benefit is the very high luminance of the virtual image. A second benefit is that the HMD is not subjected to glare when illuminated from the front with the bright sun or other lights. Another advantage is that the HMD is small, low profile, and lightweight. Still another advantage is that there is a wide field-of-view (FOV) and larger eye relief so that regular eyeglasses can be worn with the HMD. Yet another advantage is that the DE is increased up to 8-fold. An additional advantage is that the color change across the FOV is eliminated. Another advantage is that the volume SGHCL accepts a much wider range of beam angles coming from the scanning laser beam real image or laser-based microdisplay compared to regular holographic lenses based on volume holograms, which have a small range of accepted angles.

### BRIEF DESCRIPTION OF THE DRAWINGS

FIG. 1 is an illustration of one embodiment of a playback setup in vertical geometry of a full color HMD with SGHCL and microdisplay with RGB laser illumination.

FIG. 2 is an illustration of the setup for recording a reflection RGB SGHCL HMD with one guided spherical convergent beam and one spherical divergent beam.

FIG. 3 illustrates the color mixing box for red, green and blue laser wavelengths.

FIG. 4 illustrates a reflection RGB SGHCL played back directly where the diffracted beam is on the same side of the substrate as the playback beam.

FIG. 5 shows a diagram of a reflection RGB SGHCL being played back after the incident guided beam experiences total internal reflection where the diffracted beam is on the side of the substrate opposite to the playback beam.

FIG. 6 is a photo of an example setup for recording a reflection RGB SGHCL with two spherical beams with no holographic diffuser nor cylindrical lens used when recording reflection SGHCL.

FIG. 7 is a photo of an example setup for playback with no holographic diffuser nor cylindrical lens used when recording reflection SGHCL.

FIG. 8 shows a diagram showing the aberrations of the retrieved virtual image at playback when a cylinder lens is not used when recording SGHCL.

FIG. 9 is an illustration of an optimized recording setup of a reflection RGB SGHCL HMD with one guided beam going through an additional cylindrical lens to reduce astigmatism and a second beam that is a spherical divergent beam.

FIG. 10 shows a photo of an example of the retrieved virtual image when a microdisplay with a regular diffuser is used with a cylindrical lens.

FIG. 11 is an illustration of one embodiment of smart glasses with SGHCL and prescription optics.

### DETAILED DESCRIPTION OF EXEMPLARY EMBODIMENTS

The present disclosure relates to an HMD having a volume (thick) SGHCL based on thin holographic components (THC) and a scanning laser beam or a microdisplay with laser-based illumination. The microdisplay can be used or can be replaced with a focused modulated scanning laser beam, which draws a high resolution real image on a diffuser. The HMD can be full color (RGB) or monochrome with input of a single laser wavelength for monochrome and three color (RGB) laser beams for full color.

In one embodiment, the holographic substrate-guided head-mounted see-through display comprises (a) an image source comprising a focused, modulated, scanning laser beam that draws a real image on a diffuser, or a microdisplay with laser-based illumination placed in the diffuser plane; (b) an edge-illuminated transparent substrate, and; (c) a single volume reflection SGHCL. The SGHCL is index-matched to the substrate.

In another embodiment, the holographic substrate-guided head-mounted see-through display comprises (a) an image source comprising a focused modulated scanning laser beam drawing the real image on the diffuser, or microdisplay with laser-based illumination placed in this plane; (b) an edge-illuminated transparent substrate comprising an angled edge or an index-matched transparent prism, and; (c) a volume holographic continuous lens comprising a reflection substrate-guided holographic continuous lens (SGHCL), which is index-matched to the substrate, and which is rotated 180° around a perpendicular axis of symmetry passing through the center of the SGHCL; wherein upon playback, an incident guided beam experiences total internal reflection and hits the SGHCL at Bragg condition. In this embodiment, diffraction to the eyes occurs on the side of the substrate opposite to the side of the substrate near the microdisplay.

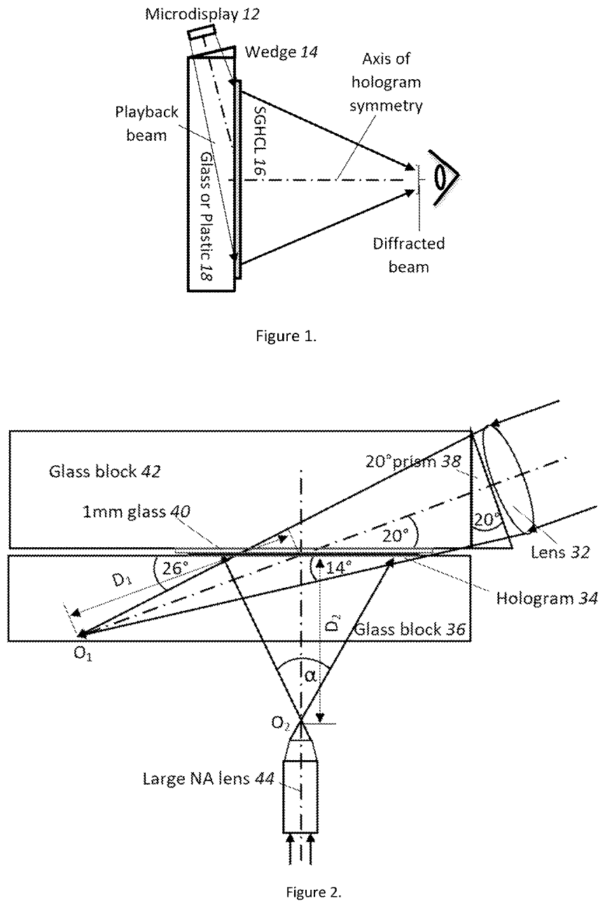

FIG. 1 illustrates an example of a playback setup 10 for an HMD having a volume RGB SGHCL with a microdisplay 12 with laser-based RGB illumination in vertical geometry. The microdisplay 12 can be either monochrome or full-color laser-illuminated front-lit LCOS, DLP, or LCD with a laser backlight. The substrate 18 is entirely transparent to provide wide see-through FOV and can be made from a number of materials, such as glass, quartz, acrylic plastic, polycarbonate plastic, or a mixture thereof. The substrate 18 can be a single plate or multiple plates and can have a variety of shapes including rectangular, oval, circular, tear-drop, hexagon, rectangular with rounded corners, square, or mixtures thereof. The side of the substrate 18 opposite to the eye can be anti-reflective (AR) coated to improve the see-through transmission. The substrate 18 also can be curved, as in prescription glasses, to correct for poor vision. A thin layer of concave glass with low refractive index can be attached to the bottom of the substrate 18 to make it compatible with prescription glasses. For a SGHCL 16 with n=1.49, the refractive index of this layer should be n=1.35 to create total internal reflection (TIR) at 25°. The thickness of the substrate 18 can be in the range of about 3-6 mm but can be thicker if necessary. The substrate 18 can be made of a single unitary body or can comprise a plurality of bodies made of the same or different transparent materials. Some edges of the substrate 18 can also be coated with a light absorptive coating, such as a black paint. The substrate 18 can also contain a tint or dye.

The substrate 18 can be angled at one end or can further include a wedged prism 14 index-matched with the end of the substrate 18 at playback. The angled edge or attached wedged prism 14 serve to minimize aberrations of the beam refracting from air in glass and can vary from 15° to 25° depending on the playback angles, substrate 18 thickness, and SGHCL 16 size. The prism 14 can be a triangular prism or a trapezoidal prism. The prism 14 can be made from a number of materials, such as glass, quartz, acrylic plastic, polycarbonate plastic, or a mixture thereof. The prism 14 can be the same material and/or composition as the substrate 18, or it can be different from the substrate 18.

The RGB laser illuminated microdisplay 12 is positioned parallel to the angled edge of the substrate 18 or the surface of the wedged prism 14 so that central beam from the microdisplay 12 is perpendicular to the substrate edge 18 to also minimize aberration at refraction. The microdisplay 12 can be directly attached to the substrate 18 or there can be a gap between the microdisplay 12 and the substrate 18. This gap allows for adjustment of the microdisplay 12 along the optical axis for focusing of the virtual image and for changing its apparent image plane. In another embodiment, the microdisplay 12 can be a monochrome microdisplay.

An RGB SGHCL 16 is laminated to the surface of the substrate 18, facing the viewer's eyes. The SGHCL 16 can be covered with a thin −100 um layer of glass for protection, and this glass can be AR coated for improved transmission. The playback geometry with the microdisplay 12 on top of the substrate 18 takes advantage of the high definition multimedia interface (HMDI) resolution with the image aspect ratio 16:9. This correlates with a 3 mm substrate 18 thickness and a microdisplay 12 of size 5.16 mm×3 mm, positioned as shown. A reflection volume SGHCL was used since its angular selectivity is much lower than that of transmission volume holograms.

The FOV of the HMD with SGHCL can be much larger than the FOV of HMD with regular SGH optics. Also, the RGB HMD with SGHCL is much smaller and lighter than the RGB HMD with regular SGH because there is only one hologram used. The HMD can be monochrome or full color. In addition, the HMD can be monocular, biocular, or binocular. HMD with SGHCL optics is not subject to glare when illuminated from the front because the diffracted light is coupled in the substrate and doesn't reach the eyes. Reflection SGHCL in RGB HMD, if rotated 180°, can work as transmission, while preserving advantages of reflection hologram, and provides flexibility in design and a larger eye relief, so regular eyeglasses can be worn underneath the HMD. Also, here the DE can be increased multifold up to about 8× greater. In addition, there is no color shift in the FOV and low power consumption due to the high DE.

FIG. 2 illustrates an example of a recording system 30 with two spherical beams for one embodiment of a reflection RGB SGHCL with recording points 01 and 02. One recording RGB beam is convergent focused in point 01 using long focus lens 32. Another RGB beam is divergent with focus in point 02 created by lens 44 with large numerical aperture (F#<1) to create large FOV. Both beams should cover the thin holographic polymer 34, which is laminated to a glass substrate 40, which is index-matched to a glass block 42. A glass substrate of approximately 1 mm can be used for convenience and stability at hologram recording and can be eliminated at playback. A 15° to 25° wedged prism 38 is attached to the glass block 42 on a side adjacent to the side of the glass block 42 having the substrate 40 attached. In one embodiment, a 20° wedge prism is used. A second glass block 36 is placed underneath the holographic polymer 34 to avoid reflection of the beam back from the bottom surface of the holographic polymer 34. In order to experience TIR and become guided, the recording beams can have angles with the glass substrate 40 surface with the holographic polymer 34 laminated therein not larger than 48° because the TIR angle for the border between air and glass is about 42°. The minimal angle with the glass substrate 40 surface with the holographic polymer 34 laminated should not be very small (<12°) because even tiny differences in the refractive index between the glass and the holographic polymer will make propagating of the shallow guided beam problematic, especially considering that the refractive indices of the holographic material are slightly different before and after recording (L1n˜0.03). The guided beams should propagate reliably during both recording and playback. The reliable guided angles should be >12° for the holographic material that is used with the average refractive index n˜1.48. In this example, the angle with the holographic polymer surface of the central beam of the spherical guided beam is 20° and a wedged 20° prism 38 attached to the glass block 42 is used to minimize aberrations of the recording spherical beam refracting from air in glass. Minimal and maximal angles in the medium of the convergent beam are 14° and 26° respectively. The angle a of the divergent beam created using large numerical aperture (NA) lens 44 is chosen to create the required FOV at playback.

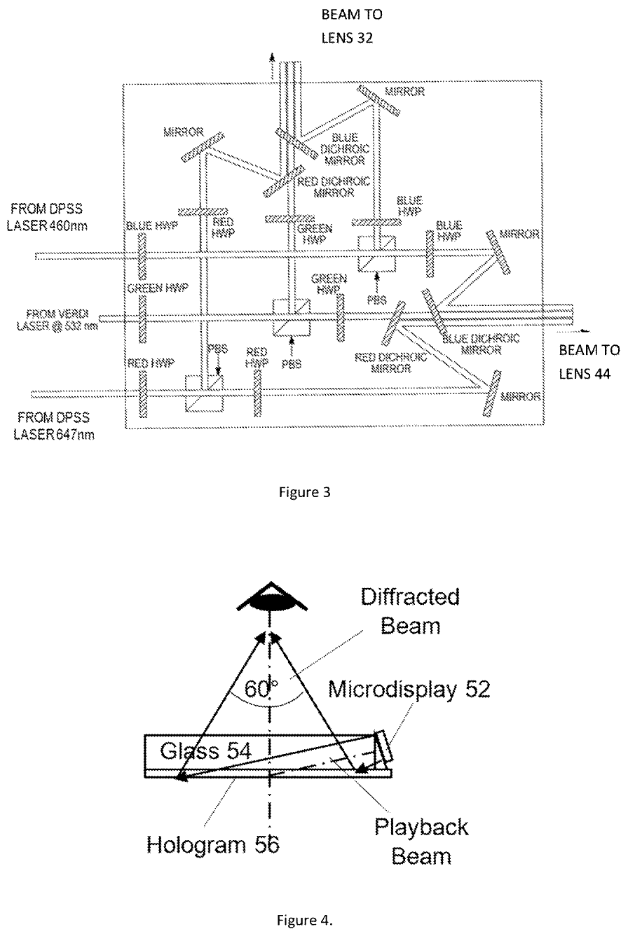

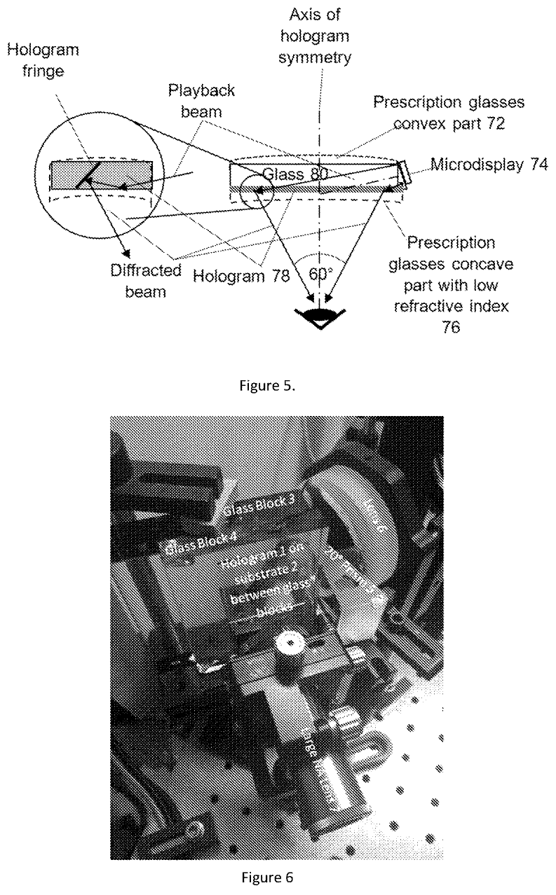

FIG. 3 illustrates the color mixing box to create RGB laser beams for hologram recording. The color mixing box contains various mirrors, which reflect and combine the colored laser light. The light will be directed to lends 32 and lens 44, as described above. After recording and processing of this reflection SGHCL, it is played back, as shown in FIGS. 4 and 5.

FIG. 4 illustrates a recorded reflection RGB SGHCL setup 50 played back directly. The setup includes a microdisplay 52, a glass substrate 54, and a hologram 56 attached to the glass substrate 54. Upon playback, the diffracted beam is on the same side of the glass substrate 54 as the playback beam from the microdisplay 52 beam hitting the thick reflection SGHCL at Bragg condition and diffracting up to the viewer's eyes.

In FIG. 5, the playback setup 70 includes prescription glasses convex part 72, a microdisplay 74 and a glass substrate 80 to which the microdisplay 74 and the prescription glasses 72 are attached. The microdisplay 74 is attached to a side of the glass substrate 80. A hologram 78 is attached to a surface of the glass substrate 80 that is different than the surface where the prescription glasses 72 are attached. A concave part of prescription glasses with low refractive index 76 is also attached to the bottom of the glass substrate 80. The microdisplay 74 and the viewer's eyes are on opposite sides of the hologram 78. The reflection RGB SGHCL is rotated 180° around an axis of symmetry passing through the center of the SGHCL perpendicular to it sides so as to work as transmission. To the left of the Figure is a magnified excerpt showing one ray of the playback beam experiencing TIR and reflecting from the SGHCL fringe. The playback guided beams impinge on the SGHCL not at Bragg, experience total internal reflection, then they are at Bragg and diffract efficiently down to the eyes. Upon playback, the SGHCL has a diffracted beam and a playback beam on a different side of the SGHCL. Here, reflection SGHCL works as transmission. Also, the eye relief is increased by a few millimeters, nearly by the thickness of the glass substrate divided by the glass refractive index. The reflection SGHCL helps to increase the FOV due to the higher wavelength selectivity as compared to transmission holograms.

FIG. 6 is a photograph of the setup for recording reflection monochrome SGHCL with 532 nm laser beams. The schematic of FIG. 2 was followed to build the monochrome recording holographic setup. There, a holographic polymer for recording SGHCL I is laminated on a I mm substrate 2, which is index matched to glass block 3. A 20° prism 5 is placed at one end of glass block 3. Glass block 4 is placed opposite the holographic polymer I to exclude TIR of the convergent guided beam from the external side of the hologram and avoid recording unwanted transmission substrate-guided hologram. For playback, a laser beam phase conjugate to the recording convergent beam is used. A microdisplay is placed closer to the recorded SGHCL as compared to the recording point 01 as shown in FIG. 2. By positioning the microdisplay closer to the SGHCL, all the field points of the microdisplay comply with Bragg condition with recorded SGHCL because the entire area where the microdisplay is positioned in the vertical direction is covered with the recording beams. Because of this shift from the distance D1 to be closer to the SGHCL, the angular range of beams coming from field points of the microdisplay in Bragg-degeneration direction, accepted by the thick hologram, increases. Also, the retrieved beams become collimated, diffracting on the created fringes when the beam that converges to the point 01 interferes with the beam that diverges from point 02. This is a significant advantage of the continuous lens as compared to the regular holographic lens that is usually recorded with one collimated beam and another spherical beam. To create collimated retrieved beams, the microdisplay is placed at a distance FEQv from the SGHCL satisfying the following Eq. (1):

$$1 / {F}_{EQV} = 1 / {D}_{1} + 1 / {D}_{2} \qquad ( 1 )$$

where D1 and D2 are shown in FIG. 2, and FEQV is equivalent focus of the recorded SGHCL. A magnified virtual image of the microdisplay is coming from infinity with each point of the virtual image formed with a collimated beam. Collimated beams are created when the playback point source is moved from the position in 01 to the position of the equivalent focus FEQV.

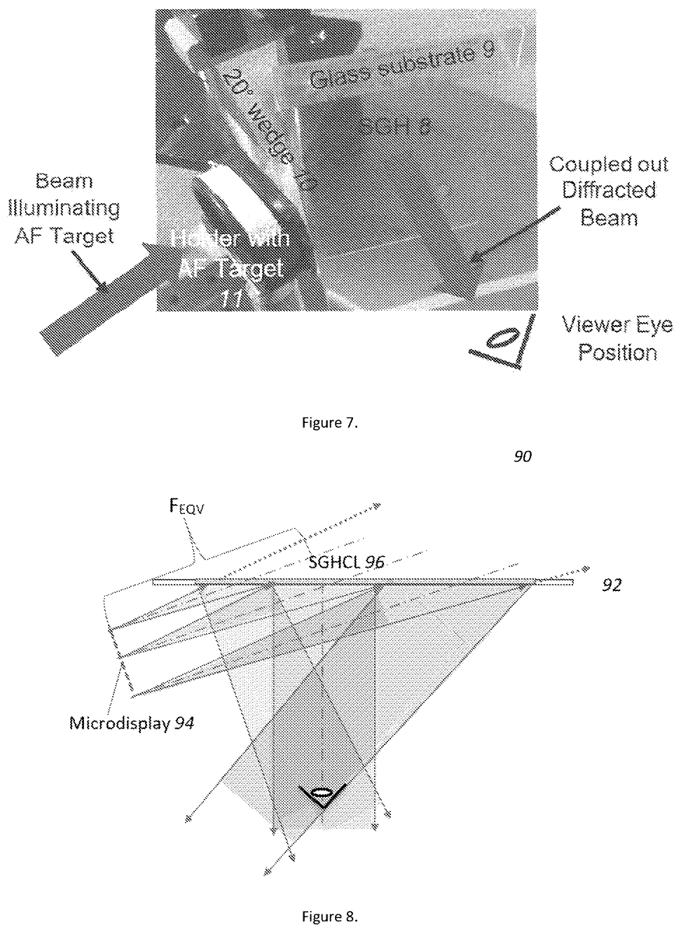

Depending on the aspect ratio of the microdisplay image, the microdisplay can be placed either at the horizontal or vertical edge of the glass substrate complying with the recorded Bragg plane of the SGHCL. For the HDMI resolution 16(H):9(V) with the vertical image size almost 2× smaller that the horizontal size, the microdisplay is placed on the top of the glass substrate. This will ensure the largest vertical FOV (based on the Bragg angular selectivity) and rather thin substrate (based on the minimal guided angle). SGHCL doesn't significantly limit the horizontal FOV because the angular selectivity is much lower in the non-Bragg degeneration direction. Depending on the HMD geometry and necessity to adjust the focusing by moving the microdisplay, the microdisplay can be either directly attached to the waveguide as shown in FIGS. 4 and 5, or there can be a gap between the microdisplay and the waveguide permitting adjustment of the focus dynamically, as shown in FIG. 1. FIG. 7 is a photo of the playback setup based on the geometry shown in FIG. 1 for testing of the recorded SGHCL using a USAF Resolution Test Target with different spatial frequency of black and white line pairs. Shown is a glass substrate 9 having the SGHCL 8 with a 20° wedged prism 10 attached to the substrate 9. A holder 11 is attached to the wedged prism 10. A beam illuminates the USAF Target and travels through the wedge into the glass substrate and through the SGHCL coupling out where the retrieved diffracted beam is seen by the viewer's eyes and can be captured with the camera.

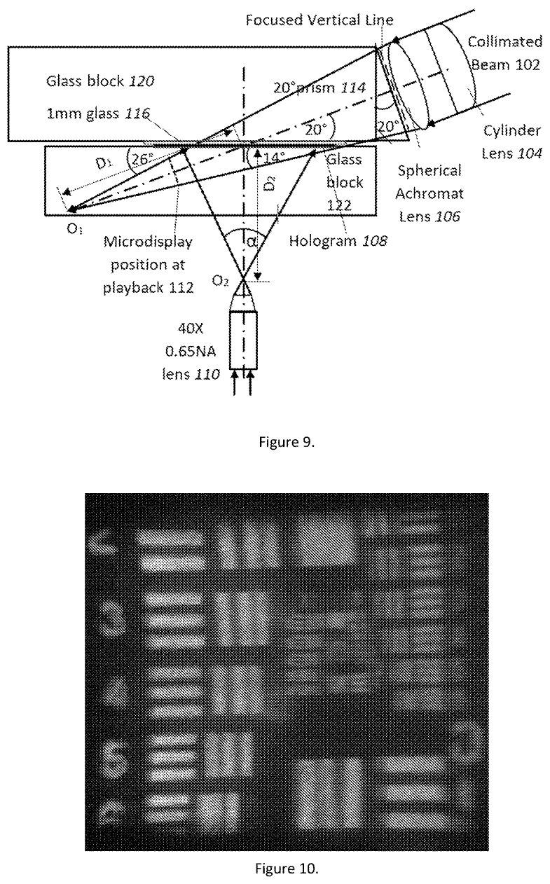

However, the retrieved virtual image was significantly aberrated. FIG. 8 demonstrates aberrations at playback 90 if a cylinder lens is not used at recording of the SGHCL 96. Because of significant tilt of the SGHCL 96 with respect the incident from the microdisplay 94 beams, the beams coming from the field points close to the SGHCL 96 diffract as divergent, and the beams coming from the field points far from the SGHCL 96 diffract as convergent. These aberrations were corrected by adding a cylindrical lens to the recording setup 100 as shown in FIG. 9.

FIG. 9 illustrates an example of a recording system 100 with two beams for one embodiment of a reflection RGB SGHCL with recording points 01 and 02. One recording RGB beam is convergent in vertical plane focused in point 01 using long focus spherical achromatic lens 106 having a collimated beam 102 entering and passing cylinder lens 104 without changes in this plane. While in the horizontal plane, the beam focuses before point 01, one position of the focused by the cylinder lens beam in the horizontal plane is shown in FIG. 9 by the vertical dashed line. This arrangement eliminates the presence of astigmatism. Another RGB beam is divergent with focus in point 02 created by lens 110 with large numerical aperture (F#<1) to create large FOV. In one embodiment, the lens is 40× and 0.65 numerical aperture (NA). Both beams should cover the thin holographic polymer 108, which is laminated to a glass substrate 116, which is index-matched to a glass block 120. A glass substrate of approximately 1 mm can be used for convenience and stability at hologram recording and can be eliminated at playback. A 15° to 25° wedged prism 114 is attached to the glass block 120 on a side adjacent to the side of the glass block 120 having the substrate 116 attached. In one embodiment, a 20° wedge prism is used to minimize aberrations of the recording spherical beam refracting from air in glass. A second glass block 122 is placed underneath the holographic polymer 108 to avoid reflection of the beam back from the bottom surface of the holographic polymer 108. In order to experience TIR and become guided, the recording beams can have angles with the glass substrate 116 surface with the holographic polymer 108 laminated therein not larger than 48° because the TIR angle for the border between air and glass is about 42°. The minimal beam angle with the glass substrate surface with the holographic polymer 108 laminated to it should not be very small (<12°) because even tiny differences in the refractive index between the glass and the holographic polymer will make propagating of the shallow guided beam problematic, especially considering that the refractive indices of the holographic material are slightly different before and after recording (L1n˜0.03). The guided beams should propagate reliably during both recording and playback. The reliable guided angles should be >12° for the holographic material that is used with the average refractive index n˜1.48. In this example, the angle with the holographic polymer surface of the central beam of the spherical guided beam is 20° and a wedged 20° prism 114 attached to the glass block 120. Minimal and maximal angles in the medium of the convergent beam are 14° and 26° respectively. The angle a of the divergent beam created using large NA lens 110 is chosen to create the required FOV at playback. The microdisplay position at playback is shown with dashed line.

An example of the retrieved virtual image with significantly reduced aberrations captured with the camera is shown in FIG. 10. Existent distortion can be eliminated either by implementing fabricated holograms or by pre-distorting the microdisplay image. Estimated FOV of the virtual image is >40°. This is an example of the largest FOV ever achieved in HMD using a single hologram. At playback the laser wavelengths should be adjusted, because at post-exposure processing hologram shrinks, and the playback wavelengths that are in Bragg should be shorter by a few nanometers. Some image blurriness in FIG. 10 may come from the inaccurate focusing by the camera to the virtual image but a significant reduction in the virtual image resolution is caused by the graininess of the diffuser that is used to create the eyebox, or the exit pupil expansion (EPE). In the situation where the head-up display (HUD) uses a 2″×4″ diffuser to create EPE, the diffuser graininess is significantly smaller than the resolution of the real image on the diffuser and the microdisplay pixels size implemented in the HMD is comparable to the features of the diffuser. By implementing a diffuser with less graininess, the resolution can be significantly improved.

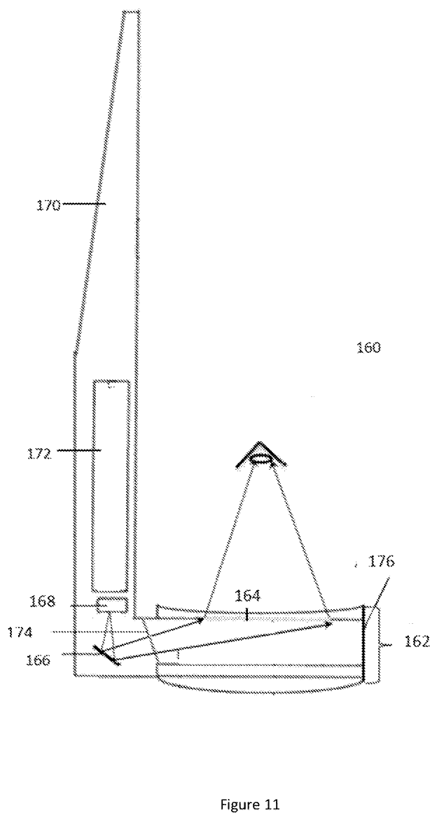

FIG. 11 illustrates an example of a partial view of smart glasses 160 using SGHCL. The scanning focused laser beam is featuring the real image in the plane of the diffuser 174 positioned at the FEQV distance from the SGHCL 164. In another embodiment, the laser beam is focused to the diffuser that is positioned at the equivalent focus from the SGHCL 164 and is either directly attached to the angled edge of the substrate or positioned at some distance of a few millimeters for better focusing. The display includes a high refractive index substrate integrated with the prescription glasses optics 162 and absorptive layer 176 preventing the laser beams leaking in air, as well as coupling light in the glass substrate from air and then have it coupled out to the eyes as unwanted glare. The SGHCL 164 is molded inside the prescription glass lens 162 for the user having impaired vision. The control electronics, miniature 3-color laser projector, earphones, and battery 172 are contained within the side arm 170 of the smart glasses 160. A scanner 168 is located near the laser included in 172 and not shown here separately. There is a turning mirror 166 within the side arm 170 that is adjacent to the scanner 168, which are both contained next to the prescription glass lens 162. The turning mirror 166 redirects the laser beam to the diffuser 174, so it hits the diffuser 174 at angle minimizing the aberrations (usually close to normal) and enters the substrate as guided beam hitting the SGHCL 164 at Bragg angle. There is a difference of the refractive indices of the SGHCL 164 and the bulk of the prescription glass lens 162 to satisfy the TIR condition on the border. These smart glasses 160 can be monocular, biocular or binocular. The smart glasses will fit comfortably on the face as regular prescription glasses with a weight less than about 100 grams. The entire assembly substrate/prescription optics/SGHCL is highly transparent. For highest transparency, the external sides can be antireflection coated or tinted. Only the right side of the frame is depicted in FIG. 11. For binocular HMD, the left side is a mirror of the depicted right side. For monocular HMD, the left side doesn't have the electronics, laser projector and hologram and will contain the battery only, which would decrease the total weight of the glasses.

Alternative embodiments of the subject matter of this application will become apparent to one of ordinary skill in the art to which the present invention pertains without departing from its spirit and scope. It is to be understood that no limitation with respect to specific embodiments shown here is intended or inferred.

We claim:

1. A holographic substrate-guided head-mounted see-through display comprising:
(a) an image source comprising a scanning laser beam or a microdisplay with laser illumination;
(b) an edge-illuminated transparent substrate, and;
(c) a single volume substrate-guided holographic continuous lens (SGHCL).

2. The holographic substrate-guided head-mounted see-through display of claim 1 wherein:
(a) the image source comprises a microdisplay with laser-based illumination;
(b) the edge-illuminated transparent substrate comprises an angled edge or an index-matched transparent prism, and;
(c) the single volume SGHCL comprises a reflection SGHCL, which is index-matched to the substrate, and which is rotated 180° around a perpendicular axis of symmetry passing through the center of the SGHCL;
wherein upon playback, an incident guided beam experiences total internal reflection and hits the SGHCL at Bragg condition.

3. The holographic substrate-guided head-mounted display of claim 1 wherein the substrate comprises a thickness of about 3-6 mm.

4. The holographic substrate-guided head-mounted display of claim 2 wherein the substrate and the prism each comprise glass, quartz, acrylic plastic, polycarbonate plastic, or a mixture thereof.

5. The holographic substrate-guided head-mounted display of claim 1 wherein the substrate comprises a single plate or multiple plates.

6. The holographic substrate-guided head-mounted display of claim 1 wherein the substrate comprises a 15°-25° angled edge or a 15°-25° index-matched prism.

7. The holographic substrate-guided head-mounted display of claim 1 wherein the microdisplay comprises a laser-illuminated monochrome or an RGB (full color) liquid crystal on silicon (LCOS), digital light processing (DLP), or liquid crystal display (LCD).

8. The holographic substrate-guided head-mounted display of claim 1 wherein a side of the substrate, opposite to an eye of the viewer, comprises an anti-reflective coating.

9. The holographic substrate-guided head-mounted display of claim 1 wherein the substrate comprises a curved shape.

10. The holographic substrate-guided head-mounted display of claim 1 wherein the substrate comprises prescription glasses.

11. The holographic substrate-guided head-mounted display of claim 1 wherein the substrate comprises a unitary body or a plurality of bodies made of the same material or different materials.

12. The holographic substrate-guided head-mounted display of claim 1 wherein one or more edges of the substrate comprise a light absorptive coating.

13. The holographic substrate-guided head-mounted display of claim 1 wherein the microdisplay is directly attached to the substrate or comprises a gap relative to the substrate.

14. The holographic substrate-guided head-mounted display of claim 1 wherein the SGHCL comprises a first side and a second side opposite to the first side; and wherein, upon playback, the SGHCL has a diffracted beam on the first side and has a playback beam on the second side.

15. The holographic substrate-guided head-mounted display of claim 1 wherein, upon playback, the SGHCL has a diffracted beam and a playback beam on a same side.

16. The holographic substrate-guided head-mounted display of claim 1 wherein the substrate comprises a shape including rectangular, oval, circular, tear-drop, hexagon, rectangular with rounded corners, square, or a mixture thereof.

17. The holographic substrate-guided head-mounted display of claim 1 wherein a retrieved image comprises a monochrome or RGB (full-color) image.

18. The holographic substrate-guided head-mounted display of claim 1 comprising a focused, modulated, scanning laser beam and a diffuser.

19. A method of recording a volume reflection SGHCL comprising shining two beams onto a holographic polymer index-matched to a substrate, wherein a first recording beam is guided from an edge of the substrate and convergent to a first focus point and a second recording beam is a divergent beam, and wherein both beams cover the holographic polymer.

20. The method of recording the volume reflection SGHCL of claim 19 wherein the substrate is index-matched to a first rectangular block having an angled edge or an index-matched prism;
wherein a first recording beam is guided and convergent with focus in a recording point 01 using a long focus lens and a second recording beam is divergent with focus 02, in a plane created by a high numerical aperture lens;
wherein a second rectangular block is placed underneath the holographic polymer to avoid total internal reflection of a guided beam back from a bottom surface of the holographic polymer to avoid recording unwanted transmission SGHCL;
wherein the recording convergent beam comprises angles with the substrate and holographic polymer less than or equal to about 48°;
wherein a reliable guided angle is greater than about 12°;
wherein a microdisplay or focused laser beams are positioned at equivalent focus of the recording convergent beam and the divergent beam;
wherein a cylinder lens is used in the convergent recording beam to minimize aberrations; wherein a position, tilt and focus of the cylinder lens are adjusted to minimize aberrations; wherein an HMD image comprises a virtual image coming from infinity; and
wherein a minimum angle of a convergent beam with a holographic polymer surface comprises about 14° and a maximal angle of the convergent beam with the holographic polymer surface comprises about 31° with a central beam having 15°-25° angle.
